(19) United States
(12) Patent Application Publication
(10) Pub. No.: US 2022/0065536 A1
(43) Pub. Date: Mar. 3, 2022

(54) COOKING APPLIANCE AND METHOD FOR OPERATING A COOKING APPLIANCE

(71) Applicant: BSH Hausgeräte GmbH, Munich (DE)

(72) Inventors: Dirk Beckmann, Raubling (DE); Hans-Martin Eiter, Kirchweidach (DE); Eckehard Reinwald, Ottobrunn (DE)

(21) Appl. No.: 17/414,988

(22) PCT Filed: Dec. 21, 2019
(86) PCT No.: PCT/EP2019/086769

§ 371 Date: Jun. 17, 2021

(30) Foreign Application Priority Data
Dec. 21, 2018 (DE) 10 2018 222 732.2
Jan. 17, 2019 (DE) 10 2019 200 583.7

(51) Int. Cl. F27D 21/02; F24C 15/00; G01J 1/44; G01J 3/50; A47J 36/32

(52) U.S. Cl. CPC F27D 21/02; F24C 15/008; F27D 2021/026; G01J 3/50; A47J 36/32; G01J 1/44

(57) ABSTRACT

In a method for operating a cooking appliance, a measurement profile is recorded of a light reflected by a food during a heat treatment cycle. A time instant of a turning point is determined from the measurement profile, and an action is triggered on the basis of the determined time instant of this turning point.

The invention relates to a method for operating a cooking appliance, in which at least one measurement profile for light reflected by a food is recording during a heat treatment cycle and a reaching of a target level of browning is determined therefrom. The invention also relates to a cooking appliance which is configured for the course of the proceedings. The invention can be applied particularly advantageously to ovens.

A level of browning of food is essentially to be viewed as a subjective, taste-dependent variable of the consumer. This hampers a reproducible recognition of the desired level of browning.

Previously known methods for assessing baking and roasting results are based in most cases on a subjective browning evaluation by means of visual assessment or on an evaluation and classification on the basis of color charts (e.g. NCS color charts, on the basis of which the brightness values are compared with a reference). This is problematic in particular with non-conventional or inhomogeneous foods. For each food, the optimal level of browning must be stored by way of a stored brightness profile, which is only barely possible in practice.

DE 10 2005 014 713 A1 discloses a sensor apparatus with a data processing unit for determining a level of browning of a food product arranged in a cooking compartment and with at least one sensor for detecting a radiation intensity reflected by the food product. In order to provide a sensor apparatus for cooking appliances, by means of which a level of browning of a food product can be determined, it is proposed that the data processing unit for determining a relevance parameter for a characteristic of the detected radiation intensity is provided as a function of the temporal course of the detected radiation intensity.

DE 10 2016 215 550 A1 discloses a method for establishing a level of browning of a food product in a cooking compartment of a household cooking appliance, which household cooking appliance has a camera directed into the cooking compartment and a light source for illuminating the cooking compartment, and wherein the camera is used to record a reference image, a first measuring image is recorded with a first brightness of the light source, a second measuring image is recorded with a second brightness of the light source, a difference image is produced from the first measuring image and the second measuring image and the difference image is compared with the reference image. A household cooking appliance has a camera directed into a cooking compartment, a light source for illuminating the cooking compartment and a control device coupled to the camera and the light source, wherein the household cooking appliance is configured to carry out the method.

EP 0 682 243 A1 specifies an apparatus and a method for measuring the level of browning of a food product, in particular a baked food, with at least one radiation source, which generates a measuring radiation and a reference radiation of different wavelength ranges, the reflection and backscatter of which is influenced differently by the level of browning of the food product, both of which are emitted onto the food product by way of optics, with a measuring sensor for detecting the radiation emitted by the food product, with a reference sensor for detecting the intensities of the measuring radiation and the reference radiation and with a device for determining the level of browning from the intensity of the measuring radiation detected by the measuring sensor, from the intensity of the reference radiation detected by the measuring sensor, from the intensity of the measuring radiation detected by the reference sensor and from the intensity of the reference radiation detected by the reference sensor.

The object of the present invention is to overcome the disadvantages of the prior art at least partially and in particular to provide an option for determining a target level of browning of the food product for a plurality of foods in a particularly reproducible and reliable manner.

This object is achieved according to the features of the independent claims. Advantageous embodiments form the subject matter of the dependent claims, the description and the drawings.

The object is achieved by a method for operating a cooking appliance, in which

at least one measurement profile of a light reflected by a food or an associated light property is recorded during a heat treatment phase,
a time instant tw of a turning point is determined from at least one measurement profile, and
at least one action is triggered on the basis of the determined time instant tw.

This method is based on the knowledge that with many browning processes, a high-quality similar measurement profile of the heat-treated food occurs: A browning of the food only changes slowly at the start of a heat treatment cycle. The speed of the browning then increases, in order, after crossing a turning point, to level the same out with increasing browning to the point of turning black. The method is based on the further knowledge that the target value (target level of browning) perceived by users to be very good or optimal for consumption typically lies in the range of the turning point. Consequently, the target level of browning which is suitable for a user can also be determined by determining the turning point or the time instant tw of the turning point, namely practically independently of the type of food.

The method advantageously enables an automatic defining of a prepared, different food only from measuring data by way of equating the time instant tw of reaching the turning point (possibly with a time offset, as described further below) with a reaching of a target level of browning which is typically desired by the user. It is possible to dispense with evaluations and classifications e.g. on the basis of color charts. The use of the turning point furthermore renders the method advantageously very robust with respect to an absolute level of the light reflected by the food, which is influenced e.g. by the type of food, by an illumination intensity (internally through light sources and/or externally through incident ambient light), by a contamination and by a sensitivity of a light sensor.

The method can also be considered to be a method for determining a target level of browning of food during a treatment by means of a cooking appliance.

The cooking appliance is used for heat treating food. It can have a cooking compartment which can be closed by means of a door or can treat the food when open. A cooking appliance, which has a cooking compartment which can be closed by means of a door, can be an oven, for instance, a microwave oven, a steamer or any combination thereof, e.g. an oven with a microwave and/or a steam treatment function.

The cooking appliance is in particular a household cooking appliance, in particular a kitchen appliance. The cooking appliance may be a uniform component, e.g. an oven, or within the context of a cooking appliance system at least two spatially distributed components. The cooking appliance can also be a small household appliance, e.g. a toaster. The method can then be used to determine a target level of browning of toast.

A “measurement profile” is understood to mean in particular the temporal course of measured values of the light reflected by the food. The measurement profile can also be referred to as a signal profile.

A “differential profile of the x'th order” is understood to mean in particular an x'th time derivative of the measurement profile. The values of the differential profile of the x'th order can correspond to the differential quotients or the differential quotients of the measured values.

If a number of e.g. locally distributed, measured values of the food are measured at a time instant, a measured value used for the measurement profile can be derived herefrom e.g. by forming the average value, by determining a median value, by selecting the pixel with the highest or the lowest light property etc. A number of measured values of a food can be received, for instance, in the case that the at least one light sensor is a camera.

A heat treatment profile is understood to mean in particular a process or process section during operation of the cooking appliance, in which heat is intentionally applied to the food, e.g. by activating at least one heat radiation source, introducing microwaves into a cooking compartment etc.

In one embodiment, at least one measurement profile is recorded in precisely one wavelength range. This can comprise light being recorded from a wavelength range per measuring time point and only this wavelength range being evaluated (single channel measurement). The wavelength or spectral range can be selected essentially arbitrarily.

In one development, the wavelength range corresponds to the visible light spectrum. This development is advantageous in that the measurement is particularly bright and can be evaluated particularly easily.

In one development, the wavelength range corresponds to at least one subarea of the visible light spectrum. Therefore the advantage is achieved in that a browning can be identified particularly well in a partial wavelength range. For instance, the subarea can achieve by means of a corresponding color discrimination in a color camera and/or by the attachment of color filters. A particularly preferred application area of this development may exist if a food or food product to be browned is initially not white, but is instead colored, e.g. green. If the green color with progressive browning passes into a brown color, the level of browning can be identified particularly reliably by receiving a measurement profile in the green and/or brown wavelength range. Another wavelength range can be a wavelength range which is sensitive to brown or brown-yellow, e.g. for the preparation of fish fingers.

The wavelength range can be fixedly predetermined or variably adjustable. A user can therefore select the wavelength range, or the cooking appliance can select the wavelength range automatically on the basis of a known type of food product defined e.g. by way of a cooking program (and thus in particular its color in the uncooked state).

One embodiment which is advantageous for optimizing the signal level, for identifying dirt and/or for compensating for dirt and for improving the robustness of the evaluation involves a number of measurement profiles being measured in different wavelength ranges and then being evaluated in order to determine the time instant tw (multi-channel measurement). To this end the cooking appliance can have light sources, for instance, which radiate the light with different wavelengths (e.g. different colored LEDs).

In one development of the multi-channel measurement, light from various wavelength ranges can be irradiated temporally in series into the cooking chamber. Furthermore, light reflected from the food can be evaluated spectroscopically, for instance in that the respective intensity relationships are determined or that temporal changes to the intensity relationships are determined. In the event that the reflected light is received pixel by pixel by means of a camera, measuring results can be evaluated spectroscopically for each pixel or for a number of groups of pixels, in each case. The wavelength range can comprise e.g. an infrared wavelength range, in particular a near infrared range and/or at least one wavelength range which is in the visible spectrum, e.g. a white range and/or a red range, a green range and a blue range.

In one development, the (“color-dependent) time instants tw for the respective color or spectral channels are calculated separately, and an “actual” time instant tw which triggers the action is determined therefrom by forming an average value of all color-dependent time instants tw. Alternatively, the actual time instant tw can be calculated in n color channels by averaging the n-1 at the adjacent color-dependent time instants tw inter alia. Alternatively, the color-dependent profiles can be averaged suitably.

In one embodiment the measurement profile is a course of a brightness of the reflected light. The measured values of the brightness profile are therefore brightness values. This embodiment is advantageous in that it can be evaluated particularly easily and robustly. A brightness of the food can be understood to mean in particular the strength or intensity of the light radiation reflected by the food into a light detector. The determination of the brightness of a food is basically well-known and is therefore not detailed further below.

If a number of locally different brightness measured values of the food are measured at one time instant, a brightness measured value for the measurement profile can be derived herefrom e.g. by means of averaging, by determining a median value, by selecting the pixel with the highest or the lowest light brightness etc. A number of brightness measured values of a food can be received for instance in the case that the at least one light sensor is a pixel-resolving camera. A brightness measured value can be assigned to any of the pixels.

If the brightness in the (entire) visible light spectrum is recorded, the brightness can then also be referred to as “black/white brightness”. It can vary in particular between dark or “black” with a practically non-existent light intensity and bright or “white” with a maximally reflected light intensity. The higher the level of browning, the lower therefore typically the brightness of the food. This development is advantageous in that the recorded brightness is particularly bright and can be evaluated particularly easily.

The brightness can however essentially also be recorded or evaluated in a subarea of the visible light spectrum.

In one development, the wavelength range corresponds to at least one subarea of the visible light spectrum. The associated brightness can then also be referred to as “color brightness”. Therefore the advantage is achieved in that a browning can be identified particularly well in a partial wavelength range. For instance, the subarea can achieve by means of a corresponding color discrimination in a color camera and/or by attaching color filters. A particularly preferred application area of this development may exist if a food or food product to be browned is not initially white, but is instead colored, e.g. green. If with progressive browning the green color passes into a brown color, the level of browning can be identified particularly reliably by recording a measurement profile in the green and/or brown wavelength range. Another wavelength range can be a wavelength range which is sensitive to the color brown or brown-yellow, e.g. for the preparation of fish fingers.

In an alternative or additional embodiment, the measurement profile can be a profile of a color saturation or a color tone of the reflected light, which may be independent of the brightness. This enables a particularly reliable determination of the browning in the event that the food is initially dark, but not brown, but is instead colored, e.g. green. If the green color passes into a brown color with progressive browning, the level of browning can be identified particularly reliably by evaluating or using a measurement profile of a color saturation of the reflected light of a green and/or brown color or color tone or the associated color portion.

In one embodiment, a time instant tw of a turning point of at least one measurement profile is determined between an accelerating and a subsequently slowing decline in the measurement profile or the profile of the measured light property (e.g. the brightness and/or the color saturation). This is particularly advantageous if the wavelength range comprises the initial color of the food product, e.g. for recording a measurement profile of a black/white brightness or a color saturation in the green color range.

In one embodiment, a time instant tw of a turning point of at least one measurement profile is determined between an accelerating and a subsequently slowing increase in the measurement profile. This is particularly advantageous if the wavelength range comprises a color of the food product which is firstly produced by browning, e.g. for receiving a measurement profile of a saturation in a wavelength range which is characteristic of a brown color or color tone.

In one development, the turning point or its time instant tw is determined as such by evaluating the measurement profile. This is advantageous in that the measurement profile does not need to be changed in a complicated fashion, which in turn saves on computing effort.

In an alternative or additional embodiment, the time instant tw of the turning point is calculated from a determination of an extreme value of the differential profile of the first order of the at least one measurement profile. The time instant tw corresponds here to an extreme value of the differential profile of the first order. The advantage is achieved in that the time instant tw can be determined particularly precisely and reliably. In one development, a minimum is determined as the extreme value, particularly if the time instant tw of the turning point is determined between an accelerating and subsequently slowing decline in the measurement profile or the measurement curve. In one development, a maximum is determined as the extreme value, particularly if the time instant tw of the turning point is determined between an accelerating and subsequently slowing increase in a color saturation.

In an alternative or additional embodiment, the time instant tw of the turning point is calculated from a determination of a turning point of a differential profile of the second order, e.g. between an accelerating and subsequently slowing increase or decrease in the differential profile. The time instant tw can also be determined more precisely and reliably than when determined from the original (not derived) measurement profile. In particular, the turning point can be determined quickly and reliably by means of a zero-crossing determination, e.g. from the negative into the positive value range, or vice versa.

In one embodiment, the action is triggered if the time instant tw of the turning point is reached. The advantage is therefore achieved in that even without user intervention an action is triggered by reaching a target level of browning which is probably favorable for a user. Since it has transpired that for the majority of users a desired target level of browning lies in the region of the turning point, this time instant tw can also be referred to as a time instant which corresponds to the standard or “normal” time instant.

In one development, the at least one action comprises at least one action from the group

terminating the heat treatment cycle, e.g. by switching off the heat sources, of the microwave generator etc.;
notifying the user e.g. via outputting a visual and/or acoustic signal, by emitting a message to a user terminal of the user etc.;
automatically opening a door of the cooking compartment.

In one embodiment, the action is triggered if the time instant of the turning point, plus a user-specific time offset Δt, is reached. This is advantageous in that individual customer expectations with respect to a target level of browning (e.g. a desire for a particularly significant browning) can be taken into consideration by setting the time offset Δt. Browning results which vary individually from the standard can thus also be easily achieved in a reproducible manner.

The time offset Δt can be positive, if a user wants a greater level of browning than normal, and in other words more browning. The action is then triggered at a time instant tw+Δt with Δt>0 and therefore after the “normal” time instant tw. The time offset Δt can alternatively be negative if a user wants a lower level of browning than normal and in other words less browning. The action is then triggered at a time instant tw+Δt with Δt>0 (alternatively also expressible as tw−Δt with Δt>0) and therefore before the “normal” time instant tw. The user can input the time offset e.g. via a user interface of the cooking appliance, possibly linked with the type of food. The time offset Δt can be an absolute or a percental offset.

In one embodiment, the measurement profile will be or is smoothed. The advantage is achieved in that outliers, measurement noise and/or brief fluctuations in the measured values are suppressed and the time instant tw can thus be determined noticeably more reliably. In one development, the measurement profile is smoothed by the associated measured values being calculated as a smoothing average from the currently measured measured value and at least one measured value measured beforehand.

In one embodiment, the measurement profile is recorded after an initial start duration of the heat treatment phase has elapsed. Measured values of the measurement profile are then only measured after the end of the initial start duration, or measured values measured within the initial start duration are not taken into account for determining the time instant tw. The advantage is achieved in that initial interference effects are not taken into account in the heat treatment of the food, which could falsify the determination of the time instant tw.

In one embodiment, a measuring rate (i.e. a measuring frequency per time unit) is increased when the turning point or the associated time instant tw is approached. This is advantageous in that the time instant tw can be determined more precisely and the number of measuring cycles can simultaneously be kept to a minimum.

In one embodiment, the time instant tw is determined by predicting the at least one profile (measurement profile, differential profile of the first order and/or differential profile of the second order). This enables a temporally particularly close correlation between the time instant tw and the triggering of the action.

Alternatively, the time instant tw is determined retrospectively which produces a lower computing outlay and, depending on the measuring rate, contains a noticeable time out beyond the time instant tw which is practically not noticeable to the user. To this end, during a cooking process, a turning point can be determined by comparing temporally consecutive values of the differential profile of the first order: from a specific number of consecutively increasing values, it can be assumed that the minimum has been crossed.

The prediction of the profile can be carried out by means of essentially well-known methods, for instance by extrapolation, linear regression etc.

In one development, the at least one profile (measurement profile, differential profile of the first order and/or differential profile of the second order) within the scope of machine learning is predicted or the machine learning methods are used to predict the profile. To this end the profiles associated with the heat treatment cycles can also remain stored as profile histories after terminating the heat treatment cycles and form a basis or a basic population for the machine learning. In one development, reference profiles for the same food treated under the same or similar boundary conditions (such as operating settings, e.g. target cooking compartment temperatures, cooking levels etc.) can be formed from the profile histories. Food with browning processes which ensue in a similar way can also be combined to form groups.

If a new heat treatment cycle is started, it is possible to identify, for instance, whether the current profile matches a reference cycle and then already promptly estimate the time instant tw of the turning point across the reference cycle. This can help for instance to adjust the measurement rate. The agreement of the current profile with a reference cycle can be checked continuously (e.g. with any new measured value) and corrected if necessary.

In one embodiment, precisely one measurement profile is recorded. Accordingly, precisely one profile (measurement profile, differential profile of the first order and/or differential profile of the second order) is subsequently also evaluated in order to ascertain the turning point or the time instant tw is determined from precisely one profile. This is advantageously associated with a particularly minimal component and computing outlay.

In one development in particular, during a heat treatment cycle

the measurement profile is recorded by measurement in temporally fixed or variable intervals and is stored as a smoothed measurement profile, possibly after an initial start duration has elapsed,
a first derivative of the smoothed profile is calculated,
the time instant tw of the turning point of the measurement profile is determined from the time instant of the minimum of the differential profile of the first order and
on the basis of the determined time instant tw, possibly plus a user-determined time offset, at least one action is triggered.

The object is also achieved by a cooking appliance, for the course of the proceedings, as described above. The cooking appliance can be embodied analogously to the method and has the same advantages.

In one embodiment, the cooking appliance has at least one light source, directed at the food, for radiating light into the cooking compartment, at least one light sensor directed at the food, an evaluation device for storing the at least one measurement profile and for determining the time instant tw of the turning point and a control device for triggering the at least one action on the basis of the determined time instant of this turning point.

If the cooking appliance has a cooking compartment, the at least one light sensor can be directed into the cooking compartment.

The at least one light source is provided in particular to illuminate the food (e.g. by illuminating the cooking compartment), for instance with visible light (e.g. white light) and/or with infrared light (e.g. NIR light). The at least one light source can comprise e.g. at least one LED.

The at least one light sensor can be a light sensor and/or an IR sensor which is sensitive in the visible spectrum (e.g. white spectrum). The at least one light sensor can comprise at least one camera.

The evaluation device can also be referred to as a data processing device. It can be a standalone component or be integrated into the control device. It is also possible for the evaluation device to be an external entity, e.g. a network server or a cloud-assisted evaluation device. The evaluation device can have at least one data memory for storing the measured values of the measurement profile.

In the event that the at least one light sensor is a camera, the evaluation device (or another electronic component) can also be configured to isolate the pixels associated with the food from the image recorded by the camera. The advantage is achieved in that pixels not associated with the food are not included in the determination of the measured values of the measurement profile. The imaging isolation of the food from the overall image of the camera can be reached for instance by pattern or object recognition. Alternatively, in particular during the initial duration, but possibly also still later, the image can be analyzed for a change in the brightness or color saturation; only pixels, in which the brightness changes noticeably or its color saturation changes noticeably, are assigned to a food. Use is made here of the fact that device components and accessory parts typically do not change their brightness or color when heated.

The above-described properties, features and advantages of this invention and the manner in which these are achieved will become clearer and more readily understandable in connection with the following schematic description of an exemplary embodiment, which will be described in further detail making reference to the drawings.

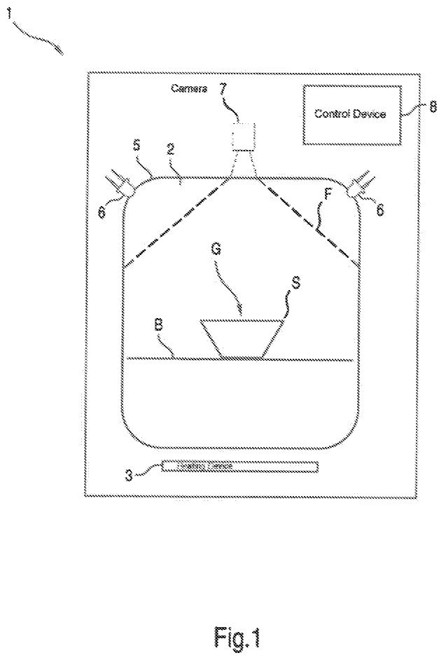

FIG. 1 shows a sectional representation in a side view of a household cooking appliance in the form of an oven; and

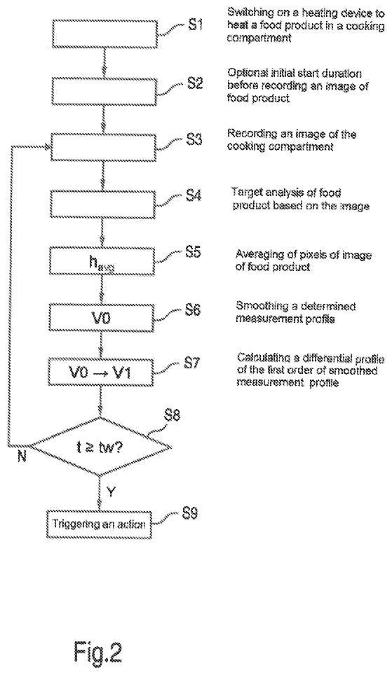

FIG. 2 shows steps of a possible method for determining the reaching of a target level of browning based on the time instant tw of the turning point of a brightness profile; and

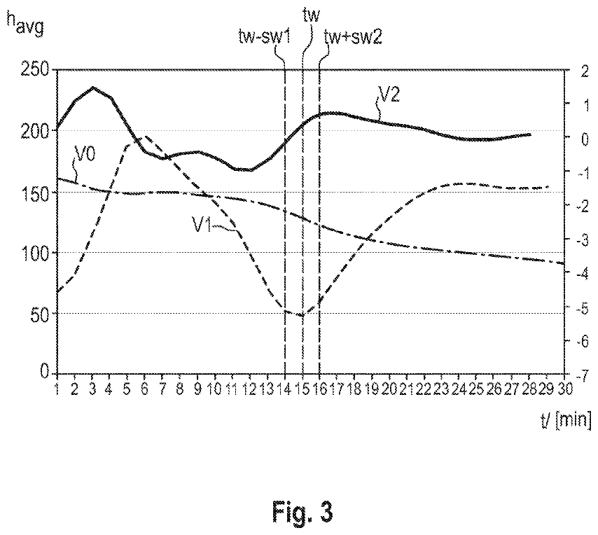

FIG. 3 shows a brightness run produced during the method and the first and second difference quotients thereof, which can be evaluated individually or in combination for determining the time instant tw.

FIG. 1 shows a household cooking appliance in the form of an oven 1. The oven 1 has a cooking compartment 2, which can be heated by means of at least one heating apparatus 3. Food product G, which is accommodated here in an item of cookware in the form of a dish S, can be introduced in the cooking compartment 2. The dish S is placed on a baking tray B.

The oven 1 also has a number of light sources introduced behind a cooking compartment wall or muffle 5 in the form of a number of LEDs 6 producing white light, the light of which falls into the cooking compartment 2 through at least one opening in the muffle 5. The at least one opening can be covered by a viewing window (not shown).

The oven 1 also has a light sensor introduced, in a ceiling of the oven muffle 5, in the form of a camera 7. The camera 7 is sensitive here for instance to the visible or “white” spectral range. A field of view F of the camera 7 is aligned here purely vertically, by way of example, and comprises parts of the muffle 5 and also the baking tray B with the dish S placed thereon. The camera 7 can be arranged in particular so that it does not directly receive light emitted by an LED 6 and also no mirroring reflex on the muffle 5. The camera 7 receives and measures therefore practically only diffusely reflected scatter light. Should however specularly reflected light be incident into the camera 7, such a reflection reflex can be detected and suppressed e.g. faded out.

The oven 1 moreover has a control device 8 provided with a data memory, said control device being used to control the oven 1, for instance to control cooking programs. It can activate the heating apparatus 3, for instance. The control device 8 can also actuate the LEDs 6 and the camera 7 and is also used to evaluate the measurement results (images) determined by the camera 7. The images are constructed on a pixel basis and have a resolution for example of 512×512 or 2048×1024 pixels.

The control device 8 is also used as an evaluation device for storing at least one measurement profile of a brightness of the food product G and for determining the time instant tw of the turning point of the measurement profile. The control device 8 can also be used for target analysis of the food product G, so that the food product G is identified and is isolated in terms of image from its surroundings. In order to record the measurement profile, only the pixels assigned to the food product G can then be used. It is in particular possible to identify different food products G and evaluate the same separately by means of target analysis.

FIG. 2 shows steps of a possible method for determining the reaching of a target level of browning based on the time instant tw of the turning point of a profile of a black-white brightness. FIG. 3 shows a number of brightness profiles which can be produced during the method and which can be evaluated in order to determine the time instant tw, namely a measurement profile V0, a differential profile of the first order V1 and a differential profile of the second order V2. In particular, the differential profile of the first order V1 corresponds to the first differential quotients of the measurement profile VO and the differential profile of the second order V2 corresponds to the second differential quotients of the measurement profile V0 or the first differential quotients of the differential profile of the first order V1.

With respect to FIG. 2, in a first step S2 of a heat treatment cycle, the heating apparatus 3 can be switched on by the control device 8, namely in the food product located in the cooking compartment 2.

In an optional step S2, an initial duration ta (e.g. between 3 and 8 minutes) can then be expected, before images which show the food product G are recorded from the cooking compartment 2 by means of the camera 7.

In step S3, at the end of the initial period of time ta, an image is recorded from the cooking compartment 2 by means of the camera 7, and triggered by the control device 8. To this end, the control device 8 can simultaneously activate the LEDs 6 in order to provide an adequately high object brightness.

In step S4, the control device 8 carries out a target analysis of the food product G on the basis of the first image, possibly also on the basis of each image, and isolates its pixels in the image with respect to its environment.

In step S4, further methods of image processing can also be applied, e.g. a pretreatment of the pixels for instance a white balance for highlighting changes in brightness.

In step S5, the control device 8 only averages the pixels of the food product G in respect of its brightness, in particular arithmetically, so that a single brightness measured value h_{avg} is determined for the food product G. An arbitrary scale of this brightness measured value h_{avg} is shown in FIG. 3 on the left x-axis.

In a step S6, at least after reaching a specific number of measured values, the last determined measured value is smoothed by means of the control device 8, e.g. by the method of the smoothing average. Alternatively, the previously recorded measured values can also be smoothed with other means. The previously recorded measured values are stored as data points of a smoothed measurement profile V0 in the data memory of the control device 8.

The measurement profile V0 shows here purely by way of example in tw=15 min a turning point between an accelerating and then slowing decrease in the average brightness h_{avg}.

In a step S7, the control device 8 will calculate the differential profile of the first order V1 as a first differential quotient of the measurement profile V0. The time instant of the minimum of the differential profile of the first order V1 corresponds to the time instant tw of the measurement profile V0.

In a step S8, the differential profile of the first order V1 is evaluated or determined to ascertain whether its minimum is reached or has been reached (“t≥tw?”. If not (“N”), a move is made back to step S3, possibly after a waiting time, which is determined by the currently set measurement rate.

If the time instant tw is reached or has been reached (“Y”), at least one action is triggered in step S9 by means of the control device 8, e.g. the heating apparatus 3 is switched off and an acoustic signal is output. The heat treatment cycle is then ended.

It may be the case that the time instant tw cannot be determined precisely, e.g. because no predictive method is used to determine the time instant tw, the measurement rate of the measurements is endless, etc. However, this is typically not critical, if the time instant lies within a time range tw−sw1≤t≤tw+sw1, since the target level of browning is then usually graded or assessed as still very good by a typical user. Generally sw1=sw2 applies, here e.g. with sw1=sw2=1 min.

It is also possible not to query the achievement of the time instant tw in step S8, but the time instant tw plus a time offset Δt with Δt>0 or Δt<0. In the case Δt<0, this is possible in particular by using predictive methods.

The present invention is naturally restricted to the exemplary embodiment shown.

Instead of the differential profile of the first order V1 the differential profile of the second order V2 can be used to determine the time instant tw. Use is made here of the fact that the turning point of the differential profile of the second order V2 between an accelerating and a subsequently slowing increase in this profile corresponds to the time instant tw of the measurement profile V0. In particular, a zero-crossing determination can be used to determine the time instant of the turning point of the differential profile of the second order V2.

A color saturation can also be evaluated instead of or in addition to an evaluation of a brightness.

In general, “a”, “one” etc. can be regarded as a singular or a plurality, in particular in the sense of “at least one” or “one or more” etc., as long as this is not explicitly excluded, e.g. by the expression “precisely one” etc.

### LIST OF REFERENCE SIGNS

1 oven
2 cooking chamber
3 heating device
5 oven muffle
6 LED
7 camera
8 control device
B baking tray
F field of view
G food product
havg averaged brightness value
S dish
S1-S9 method steps
sw1 lower threshold value
sw2 upper threshold value
t time since start of a heat treatment cycle
tw time instant of a turning point of the measurement profile VO
V0 measurement profile
V1 differential profile of the first order
V2 differential profile of the first order

1-15 (canceled)

16. A method for operating a cooking appliance, said method comprising:
recording a measurement profile of a light reflected by a food during a heat treatment cycle;
determining a time instant of a turning point from the measurement profile; and
triggering an action on the basis of the determined time instant of this turning point.

17. The method of claim 16, wherein the measurement profile is recorded in a wavelength range.

18. The method of claim 16, wherein a number of measurement profiles are recorded in different wavelength ranges.

19. The method of claim 16, wherein the measurement profile is a profile of a brightness, a color saturation or a color tone of the reflected light.

20. The method of claim 16, wherein the time instant of the turning point of the measurement profile is determined between an accelerating decrease and a subsequently slowing decrease in the measurement profile.

21. The method of claim 20, wherein the measurement profile is a brightness.

22. The method of claim 16, wherein the time instant of the turning point of the measurement profile is determined between an accelerating increase and a subsequently slowing increase in the measurement profile.

23. The method of claim 22, wherein the measurement profile is a color saturation or a color tone.

24. The method of claim 16, wherein the time instant of the turning point is calculated from a determination of an extreme value of a differential profile of a first order.

25. The method of claim 24, wherein the extreme value of the differential profile is a minimum.

26. The method of claim 16, wherein the time instant of the turning point is calculated from a determination of a turning point of a differential profile of a second order.

27. The method of claim 16, wherein the action is triggered when the time instant of the turning point is reached.

28. The method of claim 16, wherein the action is triggered, when the time instant of the turning point, plus a predefined and/or user-defined time offset, is reached.

29. The method of claim 16, wherein the measurement profile is smoothed.

30. The method of claim 16, wherein the measurement profile is recorded after an initial start duration of the heat treatment cycle has elapsed.

31. The method of claim 16, further comprising increasing a measurement rate when approaching the turning point.

32. The method of claim 16, wherein the time instant is determined by predicting the measurement profile.

33. A cooking appliance configured for carrying out a method as set forth in claim 16, said cooking appliance comprising:
a light source directing light at food in a cooking compartment;
a light sensor directed at the food to receive light reflected by the food;
an evaluation device configured to store a measurement profile recorded of the light reflected by the food during a heat treatment cycle and to determine a time instant of a turning point from the measurement profile; and
a control device configured to trigger an action on the basis of the determined time instant of the turning point.
